(19) United States
(12) Patent Application Publication
(10) Pub. No.: US 2019/0040739 A1
(43) Pub. Date: Feb. 7, 2019

(54) Real-time Automatic Custody Transfer Measurement System

(71) Applicant: Capture Automation Technology Solutions, LLC., Houston, TX (US)

(72) Inventor: Ronnie RIGGS, Houston, TX (US)

(73) Assignee: Capture Automation Technology Solutions, LLC., Houston, TX (US)

(21) Appl. No.: 16/052,241

(22) Filed: Aug. 1, 2018

Related U.S. Application Data
(60) Provisional application No. 62/540,670, filed on Aug. 3, 2017.

(51) Int. Cl. E21B 47/12; H04L 29/08; E21B 43/12; E21B 47/10

(52) U.S. Cl. CPC E21B 47/122; E21B 47/10; E21B 43/12; H04L 67/12

(57) ABSTRACT

Embodiments of Real-time Automatic Custody Transfer Measurement Systems are provided. A Real-time Automatic Custody Transfer Measurement System can be configured having a LACT or ACT unit micro-computer system, a cloud based interface and data storage system, and a remote user interface system. The LACT or ACT unit micro-computer system can be configured with a processor, memory, non-volatile memory loaded with customized software, a network interface, and input/output channels (“I/O channels”). In addition, the micro-computer system can be configured with a power supply that is wired in or an optional battery power source, and may further be optionally configured with one or more solar panels to charge the battery power source. In an embodiment the LACT or ACT unit micro-computer system can be configured with a wireless communications system that allows internet access to the cloud interface and data storage system. A remote user cloud interface system can then connect to the cloud interface and data storage system and relay real-time information to an end user regarding LACT or ACT measurements and other data.

### CROSS REFERENCE TO RELATED APPLICATION

This application is related to, and claims priority to, U.S. Provisional Patent Application Ser. No. 62/540,670, filed on Aug. 3, 2017, the disclosure of which is incorporated by reference in its entirety.

### FIELD OF THE INVENTION

Embodiments of the present disclosure relate to oil & gas Lease Automatic Custody Transfer (“LACT”) unit or Automatic Custody Transfer (“ACT”) unit measurement systems.

### BACKGROUND OF THE INVENTION

LACT unit and ACT unit measurement system have been deployed and utilized to measure the transfer of hydrocarbons from oil & gas leases to transport vehicles or pipelines and also between other facilities or transport zones for some time. Both prior systems and current systems have several shortcomings. In particular, delayed logging of measurement and other qualitative data for oil & gas being measured by LACT and ACT units and then being transported has been an issue to well owners and leaseholders for some time.

There is a present need in the oil & gas industry for advanced measuring, monitoring, and logging methods that can reliably and accurately measure, monitor, and log data from LACT, ACT, and other similar units at a particular wellsite. In particular, well owners and leaseholders are desirous of knowing the real-time status of their well output, storage tank inventory and quality, and other data associated with the oil & gas being transported through their facilities.

Prior technology in the area of LACT and ACT units measurement often relies on outdated systems that simply provide measurements that can be logged by onsite personnel or electronic systems that log measurements to readers that must later be plugged into a separate computer system to pull the measurement values from the units. It would thus be desirable to have a system that was designed towards utilizing wireless technology to provide real-time measurement and qualitative data to end users that are remotely located from the LACT and/or ACT unit measurement systems.

A new LACT unit and ACT unit measurement system and framework is thus desired that will allow for real-time measurement, monitoring, and logging. It would also be desirable for end users to be able to check the real-time measurement monitoring and logging data via a mobile device application or “app” such that the data and status of a particular wellsite is easily accessible. This could be particularly beneficial to well owners and lease holders that are actively managing the collection, storage, and transportation of oil & gas through the use of LACT, ACT, and similar units.

### SUMMARY OF THE INVENTION

Embodiments of the present disclosure aim to provide advanced oil & gas Lease Automatic Custody Transfer (“LACT”) unit or Automatic Custody Transfer (“ACT”) unit or similar measurement systems.

According to an embodiment, as Real-time Automatic Custody Transfer Measurement System is provided and configured having a LACT or ACT unit micro-computer system, a cloud based interface and data storage system, and a remote user interface system. The LACT or ACT unit micro-computer system can be configured with a processor, memory, non-volatile memory loaded with customized software, a network interface, and input/output channels (“I/O channels”). In addition, the micro-computer system can be configured with a power supply or power receiving and breakout section. For example, if the unit is receiving power from an external 24-volt power supply, it may be ideal to configure the micro-computer unit with a 24-volt breaker panel to split out power to the various components of the LACT or ACT unit micro-computer system. In an embodiment, the micro-computer system can be configured with an Ethernet switch that connects to an HMI/PLC unit. A cooling fan can also be configured in the micro-computer system to cool the components of the system.

In an embodiment, a LACT or ACT unit micro-computer system can optionally be configured with wireless communications equipment such as a cellular data communications module that may enable, for example, a 4G LTE data connection to the internet. In such an embodiment, a wireless communications antenna would optimally be connected and configured. In an embodiment, the antenna can be configured on the outside of the box the LACT or ACT unit micro-computer system is housed in or configured at a location external to the LACT or ACT unit micro-computer system, such as on an antenna tower to enable extended range communications.

According to an embodiment, a battery can also be configured to provide power to the LACT or ACT unit micro-computer system. In an alternate embodiment, one or more solar panels can further be configured to supply power to the battery to provide power to the LACT or ACT unit micro-computer system.

An electronic access keypad can also be configured mounted externally and connected to the LACT or ACT unit micro-computer system. Access codes can be configured to interface with the system, thereby providing a security component for those wishing to interface with and transfer through the LACT or ACT system. In a further embodiment, the keypad can also be used to enter information into the LACT or ACT system and/or to access and navigate menus on a screen that can be configured with the system.

In hot climate or other severe weather locations it may be ideal to select and configure high temperature components for the LACT or ACT unit micro-computer system. Water-tight housing for the system may also be preferred.

The input/output channels (“I/O channels”) can provide connections to sensors typically configured in LACT or ACT measurement units, such that sensor data can be observed, logged, and communicated. Example sensors that may be configured to connect to the LACT or ACT unit micro-computer system include: flow rate sensors, API gravity sensors, suction PSI sensors, discharge PSI sensors, BS&W sensors, temperature sensors, motor amp sensors. Other sensors/systems can also be configured such as cameras. In addition, counts sensors can also be configured on the I/O channels, counts values stored can include current counts, monthly counts, master counts, and other interval counts, which can be programmed and offered as desired. Tank volume and capacity sensors can also be configured. In an alternative embodiment, the described sensor data can also be obtained through pre-existing interfaces such as an Ethernet or other network or bus connection to a pre-existing LACT or ACT measurement system that provides sensor data through one a pre-existing interface.

As referenced above, the Real-time Automatic Custody Transfer Measurement System can further be configured with a cloud based data storage system, and a remote user interface system. The cloud based data storage system can be accessed through the LACT or ACT unit micro-computer system's network interface connected wireless communications system, such as a 4G LTE system. The cloud connection allows sensor values to be stored to the cloud in real-time and then accessed from the cloud via a remote user interface system.

### BRIEF DESCRIPTION OF THE DRAWINGS

The foregoing aspects, features, and advantages of embodiments of the present disclosure will further be appreciated when considered with reference to the following description of embodiments and accompanying drawings. In describing embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

FIG. 1 illustrates a block diagram showing one possible configuration of a LACT or ACT unit micro-computer system.

FIG. 2 illustrates a block diagram showing one possible configuration of a LACT or ACT unit micro-computer system configured with wireless communications equipment and an external wireless communications antenna.

FIG. 3 illustrates a block diagram showing one possible configuration of a LACT or ACT unit micro-computer system configured with external wireless communications equipment and an external wireless communications antenna.

FIG. 4 illustrates a block diagram showing one possible configuration of a LACT or ACT unit micro-computer system configured with wireless communications equipment, an external wireless communications antenna, and a battery and solar panel to provide power to the system.

FIG. 5 illustrates a block diagram showing one possible configuration of a LACT or ACT unit micro-computer system input/output channel (“I/O channel”) configuration.

FIG. 6 illustrates a block diagram showing one possible configuration of a Real-time Automatic Custody Transfer Measurement System configured with a LACT or ACT unit micro-computer system, a cloud based interface and data storage system, and a remote user interface system that is further configured with a graphical display system and real-time information display.

FIG. 7 illustrates a block diagram showing one possible configuration of a LACT or ACT unit micro-computer system input/output channel (“I/O channel”) configuration wherein the system is configured to communicate with a chemical injection pump controller on a wellsite.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention Like reference numerals refer to like elements throughout the specification.

Hereinafter, various embodiments of the present invention will be described in detail with reference to the accompanying drawings.

Embodiments of a Real-time Automatic Custody Transfer Measurement System are provided and described herein. A Real-time Automatic Custody Transfer Measurement System can be configured to have a LACT or ACT unit micro-computer system, a cloud based interface and data storage system, and a remote user interface system.

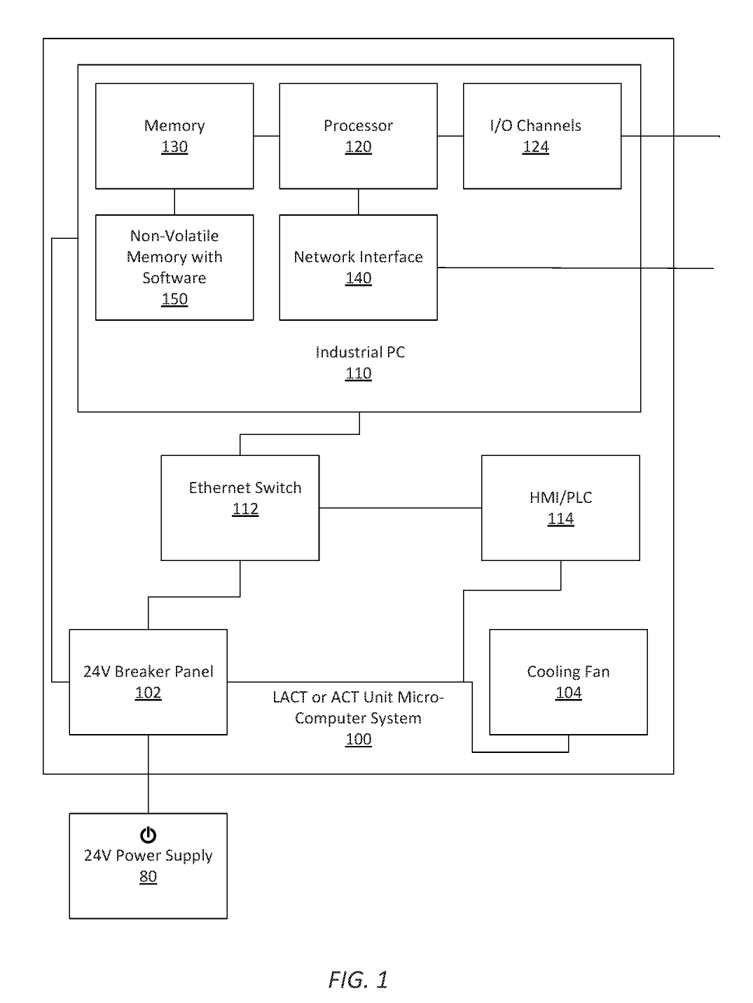

Referring to FIG. 1 an embodiment of a LACT or ACT unit micro-computer system 100 is shown. The LACT or ACT unit micro-computer system 100 can be configured with a computer or micro-computer system motherboard 110 which may also be referenced as “industrial PC,” “industrial PC board,” or “industrial PC section board,” processor 120, memory 130, non-volatile memory loaded with customized software 150, a network interface 140, and input/output channels 124 (“I/O channels”). In addition, in an embodiment, the LACT or ACT unit micro-computer system 100 can be configured with a 24-volt power supply 80 and a power receiving 24-volt breaker panel 102. In an embodiment where the LACT or ACT unit micro-computer system 100 is receiving power from an external 24-volt power supply 80, it may be ideal to configure the system 100 with a 24-volt breaker panel to split out power to the various components of the LACT or ACT unit micro-computer system 100 onto separate circuits. In an embodiment, the LACT or ACT unit micro-computer system can be configured with an Ethernet switch 112 that connects to an HMI/PLC unit 114. A cooling fan 104 can also be configured in the micro-computer system to cool the components of the system.

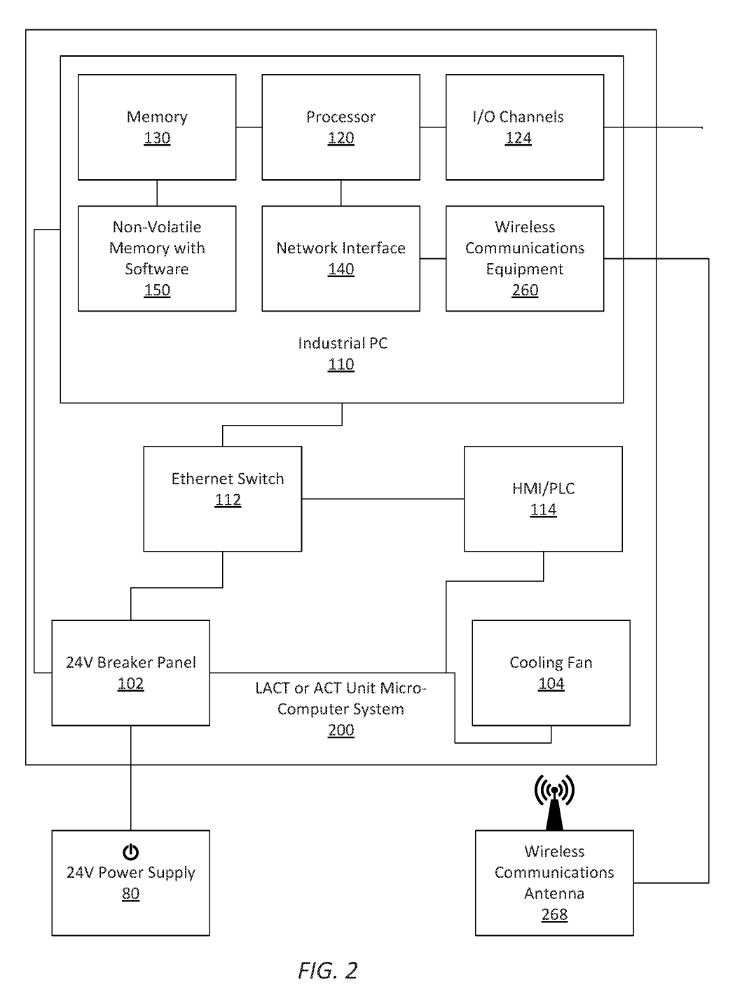

Referring to FIG. 2 an embodiment of a LACT or ACT unit micro-computer system 200 is shown. The LACT or ACT unit micro-computer system 200 can be configured in a similar manner and using some of the same components as the system described with respect to FIG. 1. Again referring to FIG. 2, the system 200 can be configured with a processor 120, memory 130, non-volatile memory loaded with customized software 150, a network interface 140, and input/output channels 124 (“I/O channels”). In addition, in an embodiment, the LACT or ACT unit micro-computer system 200 can be configured with a 24-volt power supply 80 and a power receiving 24-volt breaker panel 102. In an embodiment where the LACT or ACT unit micro-computer system 200 is receiving power from an external 24-volt power supply 80, it may be ideal to configure the system 200 with a 24-volt breaker panel to split out power to the various components of the LACT or ACT unit micro-computer system 200 onto separate circuits. In an embodiment, the LACT or ACT unit micro-computer system can be configured with an Ethernet switch 112 that connects to an HMI/PLC unit 114. A cooling fan 104 can also be configured in the micro-computer system to cool the components of the system. In an embodiment, a LACT or ACT unit micro-computer system can optionally be configured with wireless communications equipment 260 such as a cellular data communications module that may enable, for example, a 4G LTE data connection to the Internet. In such an embodiment, a wireless communications antenna 268 can be connected and configured. The antenna 268 can be configured on the outside of the box the LACT or ACT unit micro-computer system 200 is housed in or configured at a location external to the LACT or ACT unit micro-computer system 200, such as on an antenna tower to enable extended range communications.

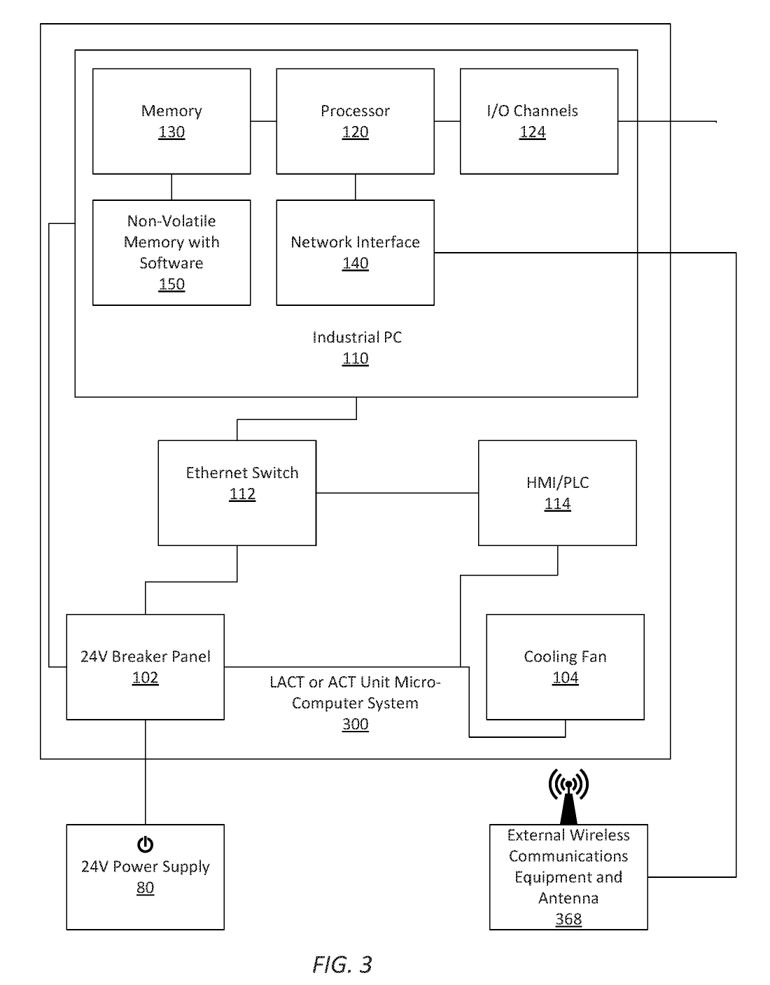

Referring to FIG. 3 an embodiment of a LACT or ACT unit micro-computer system 300 is shown. The LACT or ACT unit micro-computer system 300 can be configured in a similar manner and using some of the same components as the system described with respect to FIGS. 1 and 2. Again referring to FIG. 3, the system 300 can be configured with a processor 120, memory 130, non-volatile memory loaded with customized software 150, a network interface 140, and input/output channels 124 (“I/O channels”). In addition, in an embodiment, the LACT or ACT unit micro-computer system 300 can be configured with a 24-volt power supply 80 and a power receiving 24-volt breaker panel 102. In an embodiment where the LACT or ACT unit micro-computer system 300 is receiving power from an external 24-volt power supply 80, it may be ideal to configure the system 300 with a 24-volt breaker panel to split out power to the various components of the LACT or ACT unit micro-computer system 300 onto separate circuits. In an embodiment, the LACT or ACT unit micro-computer system can be configured with an Ethernet switch 112 that connects to an HMI/PLC unit 114. A cooling fan 104 can also be configured in the micro-computer system to cool the components of the system. In an embodiment, a LACT or ACT unit micro-computer system can optionally be configured with external wireless communications equipment and antenna 368 such as a cellular data communications module including antenna that may enable, for example, a 4G LTE data connection to the internet. The wireless communications equipment and antenna 368 can be configured away from the system 200, such as on an antenna tower to enable extended range communications of the system 200.

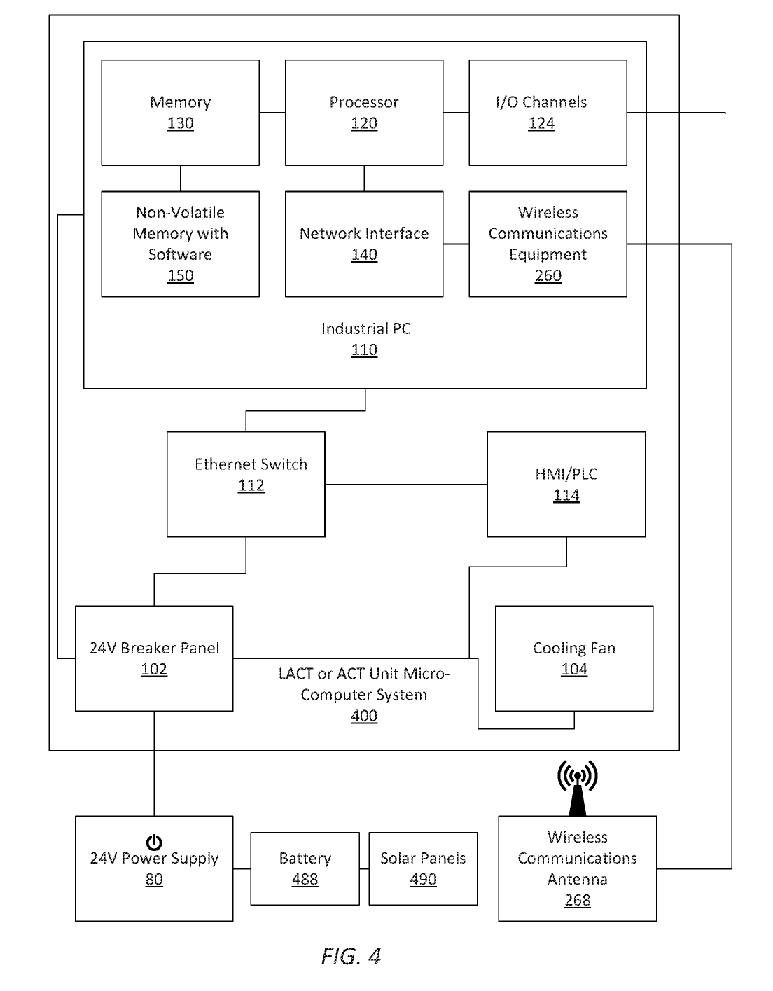

Referring to FIG. 4 an embodiment of a LACT or ACT unit micro-computer system 400 is shown. The LACT or ACT unit micro-computer system 400 can be configured in a similar manner and using some of the same components as the system described with respect to FIGS. 1 and 2. Again referring to FIG. 4, the system 400 can be configured with a processor 120, memory 130, non-volatile memory loaded with customized software 150, a network interface 140, and input/output channels 124 (“I/O channels”). In addition, in an embodiment, the LACT or ACT unit micro-computer system 4200 can be configured with a 24-volt power supply 80 and a power receiving 24-volt breaker panel 102. In an embodiment where the LACT or ACT unit micro-computer system 400 is receiving power from an external 24-volt power supply 80, it may be ideal to configure the system 400 with a 24-volt breaker panel to split out power to the various components of the LACT or ACT unit micro-computer system 400 onto separate circuits. In an embodiment, the LACT or ACT unit micro-computer system can be configured with an Ethernet switch 112 that connects to an HMI/PLC unit 114. A cooling fan 104 can also be configured in the micro-computer system to cool the components of the system. In an embodiment, a LACT or ACT unit micro-computer system can optionally be configured with wireless communications equipment 260 such as a cellular data communications module that may enable, for example, a 4G LTE data connection to the internet. In such an embodiment, a wireless communications antenna 268 can be connected and configured. The antenna 268 can be configured on the outside of the box the LACT or ACT unit micro-computer system 400 is housed in or configured at a location external to the LACT or ACT unit micro-computer system 400, such as on an antenna tower to enable extended range communications. In an embodiment, a battery 488 can also be configured to provide power to the LACT or ACT unit micro-computer system 400 power supply 80 and can further optionally be configured with one or more solar power panels 490 to charge the battery 488.

In hot climate or other severe weather locations it may be ideal to select and configure high temperature rated and/or tested components for the LACT or ACT unit micro-computer system. Water-tight housing for the system or certain components or sub-components of the system may also be preferred. In an embodiment, the system may also be partially buried at a particular wellsite to aid in controlling the temperatures the system may be exposed to.

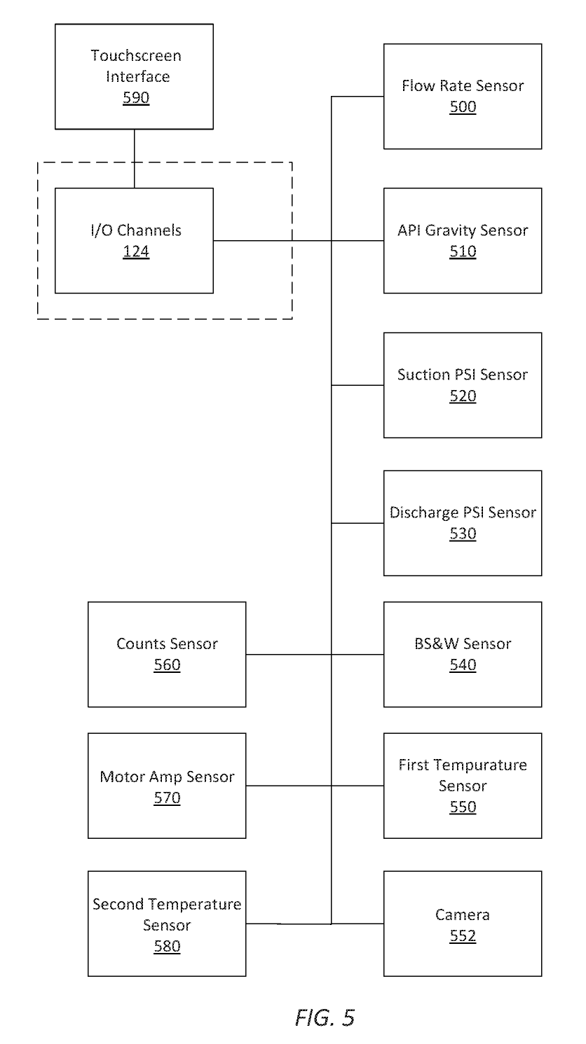

Referring to FIG. 5, the input/output channels 124 (“I/O channels”) as shown and described with respect to FIGS. 1-4, can provide connections to sensors typically configured in LACT or ACT measurement units. Sensor data can then be observed, logged, and communicated. In an embodiment, and as shown in the example illustrated in FIG. 5, the sensors that may be configured or connect with the LACT or ACT unit micro-computer system can include the following: a flow rate sensor 500, an API gravity sensor 510, a suction PSI sensor 520, a discharge PSI sensor 530, a BS&W sensor 540, a first temperature sensor 550, a camera 552, a counts sensor 560, a motor amp sensor 570, and a second temperature sensor 580. In addition, one or more counts sensors 560 can also be configured, counts values monitored, stored, and logged can include current counts, monthly counts, master counts, and other interval counts, which can be programmed and offered as desired. Tank volume and capacity sensors can also be configured (not shown). One or more of each of the listed sensors can be configured in an embodiment.

In a particular embodiment it may be desirable to only configure or connect with a subset of the sensors illustrated in FIG. 5. In an alternative embodiment, the described sensor data can also be obtained through pre-existing interfaces such as an Ethernet or other network or bus connection to an existing LACT or ACT measurement system that provides sensor data through a pre-existing interface. For such a configured LACT or ACT unit micro-computer system, the sensor data can be obtained through configured I/O channels or through the network interface or through the Ethernet switch, or from the HMI/PLC unit, or through a combination of any of these.

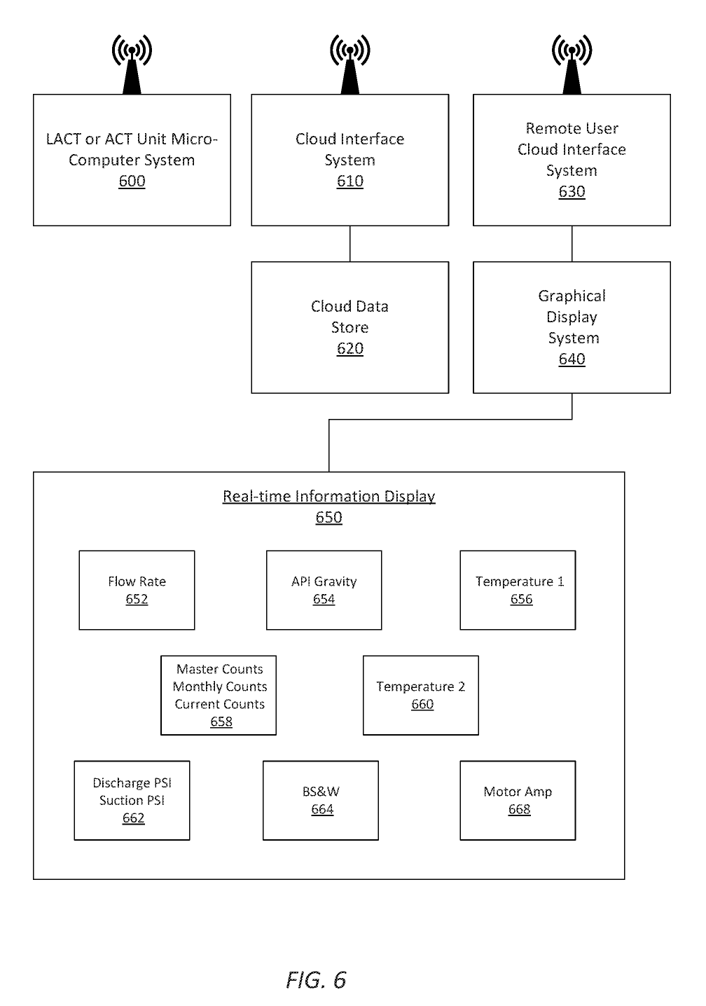

In an embodiment, and as shown in FIG. 6, a Real-time Automatic Custody Transfer Measurement System is provided and described and can be configured to have a LACT or ACT unit micro-computer system 600, a cloud based interface 610 and cloud data store 620, and a remote user cloud interface system 630 (also referred to as a remote user interface system).

The cloud based interface 610 and cloud data store 620 can be accessed through a LACT or ACT unit micro-computer system 600. As described in regard to previous embodiments, the LACT or ACT unit micro-computer system 600 can be configured with a network interface connected wireless communications system, such as a 4G LTE system, that allows wireless communications between the LACT or ACT unit micro-computer system 600 and the cloud interface 610 and cloud data store 620. The wireless connection to the cloud and a cloud data store allows sensor values to be stored to the cloud in real-time and then accessed from the cloud in real-time via a remote user interface system 630.

In an embodiment, and as shown in FIG. 6, the remote user interface system 630 can be configured with a graphical display system 640. The graphical display system 640 can include a real-time information display 650. The real-time information display 650 can be configured to show various pieces of information regarding the information stored in the cloud interface 610 and cloud data store 620. For example, the real-time information display can be configured to show real-time Flow Rate 652; API Gravity 654; Temperature 1 656; Master Counts, Monthly Counts, and Current Counts 658; Temperature 2 660; Discharge PSI and Suction PSI 662; BS&W 664, and Motor Amperage 668. This information can be displayed through a web interface that formats the information in a useable format for an end-user such as a land owner, mineral rights holder, or other individual. In an embodiment, it may be ideal to show only a partial set or subset of the values described. Graphical historical information can also be shown for particular values that have been logged and tracked to the cloud over time.

Described generally, the Real-time Automatic Custody Transfer Measurement System or “Cats System” can be used in an embodiment for a LACT unit application and will benefit the customer or end user by pulling the information on the skid to the cloud. From there the system will allow the customer to view his or her LACT skid data in real-time. Depending on the configuration of a particular system and what sensors are operational and configured, an end user will be able to view the API Gravity, Average Temperature, BS&W, Tank Levels and total barrel counts. This will allow an end user to make changes in the loads they bring in so they stay within their contracted oil requirements, thus allowing them to not have any docks on their end product. Managing these contracted requirements and optimizing operations could be extremely difficult on prior systems. This system is intended to be utilized by end users in such a way that it should help by saving an end user a tremendous amount of money by monitoring the real-time data feeds regularly and making decisions about the management of a particular site based on the data. The described embodiments of the Real-time Automatic Custody Transfer Measurement System will utilize the cloud to securely store information and show it in real-time. In an embodiment, a customer will be able to access this information from a secure phone app, PC or tablet. The data can be displayed in a webpage format, through a phone or tablet application or “app,” or through similar means.

In an embodiment, the Real-time Automatic Custody Transfer Measurement System or “Cats System” will benefit a customer by allowing an end user to view data before and after driver loads that are brought in and unloaded. The granular detail can be critical for an end user seeking to manage a particular site. This system can further be configured to work alongside multiple sample systems and be able to separate the data from each company, driver and the status of his or her load. From here the owner or lessee of the ACT unit can see data in real-time. In an embodiment, data from each load can be put into a spreadsheet, so that it may be tracked over time. Logged information from the loads can include: Company, Driver, Lease Name, Barrel Count, API Gravity, Average Temperature and BS&W. This system can provide capability to track multiple third party trucking companies. Further, the system can be configured such that each driver can print multiple receipts for total station inventory. The system will allow for the secure storage of this information and the secure review of this information, all in real-time.

For the application of natural gas measurement, the Real-time Automatic Custody Transfer Measurement System or “Cats System” is beneficial in that it can replace the use of onsite SCADA systems. At a given job site, a customer may have a flow computer onsite, for example, an ABB Total Flow or an Emerson Flo Boss computer. For such a pre-existing system, the Cats System can connect via Ethernet cable or RS232-485 Modbus to the pre-existing flow computers. In such an embodiment, the Cats System can pull the pertinent information in and utilize the cloud to store data as well as give real-time data on the flow of the well. The customer or remote end-user will be able to access this information from a secure phone app, PC or tablet.

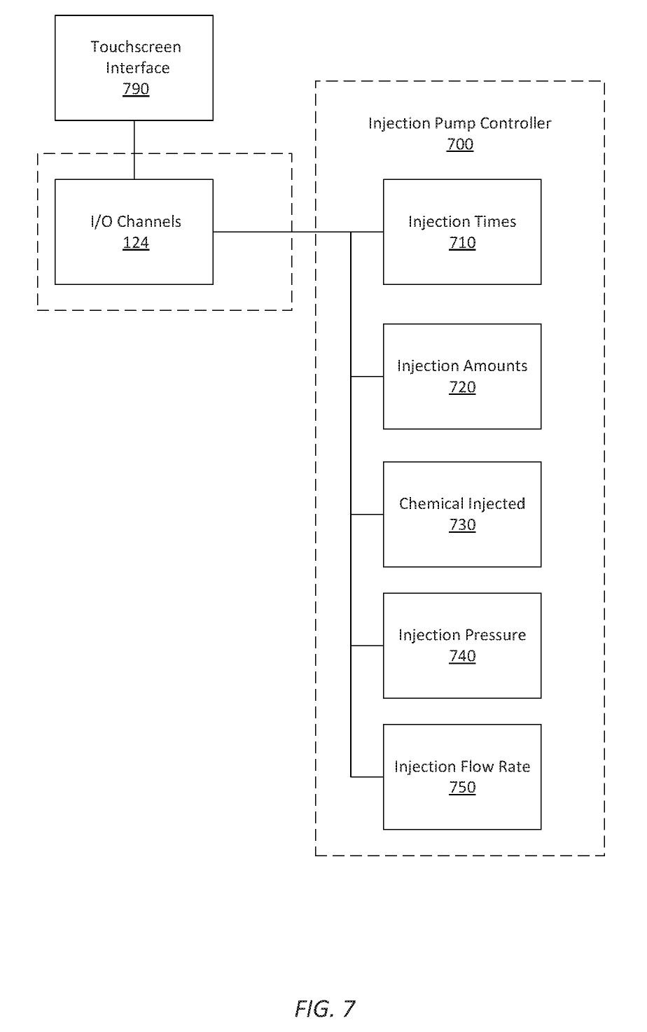

Referring to FIG. 7, the input/output channels 124 (“I/O channels”) as shown and described with respect to FIGS. 1-4, in an embodiment, can provide connections to chemical injection pump controllers that can be configured at a wellsite alongside or as a part of LACT or ACT measurement units. Controller and sensor data from the injection pump controllers can then be observed, logged, and communicated by the LACT or ACT unit micro-computer system. In an embodiment, and as shown in the example illustrated in FIG. 7, an injection pump controller 700 can be configured to connect to I/O Channels 124. The injection pump controller can be connected via modbus 485 or by other bus configurations discussed herein. In an embodiment. injection sensor data or other injection pump controller data can be stored into the cloud to provide an end user live injection information as well as historical injection data. For example, in an embodiment, and as shown in FIG. 7, the injection pump controller can be configured to provide data to the LACT or ACT unit micro-computer system over the input/output channels such as injection time data 710, injection amount data 720, identity data regarding chemical injections 730, injection pressure data 740, and injection flow rate data 750. In addition, in another embodiment, one or more of each of the sensor types shown and listed with respect to the embodiments and descriptions associated with FIG. 5, may be configured as part of the system shown and described with respect to FIG. 7.

In an embodiment, data sent by an LACT or ACT unit micro-computer system to the cloud can be encrypted before sending to provide additional security for the data sets being transmitted. For example, well-known cloud storage providers often provide security encryption certification and other encryption schemes as part of their cloud communications systems and protocols. These security measures can be integrated to the LACT or ACT unit micro-computer systems described herein to protect data being sent to and received from the cloud. In an embodiment, local password protection and encryption can be implemented to protect locally stored data.

In an embodiment, a micro-computer based Real-time Automatic Custody Transfer Measurement System configured on a LACT or ACT unit can further be configured to log and store sensor data during communications outages, flagging that data as not yet sent. The system can also be configured to communicate the flagged sensor data to the cloud based interface and data storage system at a later time once the system has determined that communications have been restored.

In an embodiment, real-time sensor information may be delayed such that the information is displayed to an end user milliseconds, seconds or possibly minutes after the data is initially gathered.

In an embodiment, the Real-time Automatic Custody Transfer Measurement System or “Cats System” can also be configured for the application of a SWD or Saltwater Disposal. In such an application, it may be beneficial to configure the system to pull in data such as pressure, flow rate, total gallons and tank levels. This data can be accessed, stored, monitored, logged, and displayed in a similar manner as the embodiments described herein.

From the description provided above, numerous different embodiments of the invention including software are envisioned that can be combined with general purpose hardware. A computer system can be created with various components to carry out the methods of the various embodiments including a non-transitory computer readable medium that can contain instructions for a software program to implement the method of the embodiments.

The above disclosure is meant to be illustrative of the various embodiments of the present invention. Various modifications will become apparent to those skilled in the art once the disclosure is considered as a whole.

1. A micro-computer based Real-time Automatic Custody Transfer Measurement System configured on a LACT or ACT unit, comprising:
a LACT or ACT unit micro-computer system, the LACT or ACT unit micro-computer system further comprising:
an industrial PC board,
a microprocessor configured on the industrial PC board, the microprocessor configured to connect to input/output channels via an input/output data bus,
memory configured to be in communication with the microprocessor,
a data bus extending between the memory and the microprocessor,
a network interface configured to be in communication with the microprocessor,
non-volatile memory configured to be in communication with the microprocessor,
wireless communications equipment configured to be in communication with the network interface,
a wireless antenna connected to the wireless communications equipment, and
a software program stored on the nonvolatile memory that enables the micro-processor to communicate with a cloud based interface and data storage system such that data values received from sensors configured on the input/output channels can be communicated to the cloud based interface and data storage system; and
a remote user cloud interface system configured to connect to the cloud based interface and data storage system and further connected to a graphical display system configured to display real-time information received from the cloud based interface and data storage system.

2. The micro-computer based Real-time Automatic Custody Transfer Measurement System configured on a LACT or ACT unit of claim 1, wherein the wireless communications equipment comprises 4G LTE wireless communications hardware and the wireless antenna comprises a 4G LTE compatible wireless antenna.

3. The micro-computer based Real-time Automatic Custody Transfer Measurement System configured on a LACT or ACT unit of claim 1, wherein the LACT or ACT unit micro-computer system further comprises a 24-volt power supply and a 24-volt breaker panel.

4. The micro-computer based Real-time Automatic Custody Transfer Measurement System configured on a LACT or ACT unit of claim 3, wherein the 24-volt power supply and a 24-volt breaker panel are further connected to a battery and solar panels that provide electricity to the system.

5. The micro-computer based Real-time Automatic Custody Transfer Measurement System configured on a LACT or ACT unit of claim 1, wherein the sensors configured on the input/output channels comprise at least a counts sensor and a flow rate sensor.

6. The micro-computer based Real-time Automatic Custody Transfer Measurement System configured on a LACT or ACT unit of claim 5, further configured to log and communicate sensor data to the cloud based interface and data storage system.

7. The micro-computer based Real-time Automatic Custody Transfer Measurement System configured on a LACT or ACT unit of claim 1, further configured to log and store sensor data during communications outages, flagging that data as not yet sent, and configured to communicate the flagged sensor data to the cloud based interface and data storage system at a later time when communications have been restored.

8. The micro-computer based Real-time Automatic Custody Transfer Measurement System configured on a LACT or ACT unit of claim 1, wherein the input/output channels connect to an injection pump controller.

9. The micro-computer based Real-time Automatic Custody Transfer Measurement System configured on a LACT or ACT unit of claim 8, wherein the injection pump controller provides data to the LACT or ACT unit micro-computer system over the input/output channels that comprises at least: injection time data, injection amount data, identity data regarding chemical injections, injection pressure data, and injection flow rate data.

10. The micro-computer based Real-time Automatic Custody Transfer Measurement System configured on a LACT or ACT unit of claim 8, wherein the software program stored on the nonvolatile memory further enables the micro-processor to communicate with the cloud based interface and data storage system to store the data values received from the injection pump controller connected on the input/output channels; and the remote user cloud interface system is further configured to connect to the cloud based interface and data storage system such that the graphical display system configured to display real-time information received from the cloud based interface and data storage system can also display the data values received from the injection pump controller.

11. A method of real-time monitoring with a micro-computer based Real-time Automatic Custody Transfer Measurement System configured on a LACT or ACT unit, the system comprising:
a LACT or ACT unit micro-computer system, the LACT or ACT unit micro-computer system further comprising:
an industrial PC board,
a microprocessor configured on the industrial PC board, the microprocessor configured to connect to input/output channels via an input/output data bus,
memory configured to be in communication with the microprocessor,
a data bus extending between the memory and the microprocessor,
a network interface configured to be in communication with the microprocessor,
non-volatile memory configured to be in communication with the microprocessor,
wireless communications equipment configured to be in communication with the network interface,
a wireless antenna connected to the wireless communications equipment, and
a software program stored on the nonvolatile memory that enables the micro-processor to communicate with a cloud based interface and data storage system such that data values received from sensors configured on the input/output channels can be communicated to the cloud based interface and data storage system; and
a remote user cloud interface system configured to connect to the cloud based interface and data storage system and further connected to a graphical display system configured to display real-time information received from the cloud based interface and data storage system;
the system performing at least the following steps:
logging sensor data received from the sensors configured on the input/output channels, and
communicating the logged sensor data to the cloud based interface and data storage system such that a remote user can then connect to the cloud based interface and data storage system and view real-time information received from the cloud based interface and data storage system.

12. The micro-computer based Real-time Automatic Custody Transfer Measurement System configured on a LACT or ACT unit of claim 11, wherein the wireless communications equipment comprises 4G LTE wireless communications hardware and the wireless antenna comprises a 4G LTE compatible wireless antenna.

13. The micro-computer based Real-time Automatic Custody Transfer Measurement System configured on a LACT or ACT unit of claim 11, wherein the LACT or ACT unit micro-computer system further comprises a 24-volt power supply and a 24-volt breaker panel.

14. The micro-computer based Real-time Automatic Custody Transfer Measurement System configured on a LACT or ACT unit of claim 13, wherein the 24-volt power supply and a 24-volt breaker panel are further connected to a battery and solar panels that provide electricity to the system.

15. The micro-computer based Real-time Automatic Custody Transfer Measurement System configured on a LACT or ACT unit of claim 11, wherein the sensors configured on the input/output channels comprise at least a counts sensor and a flow rate sensor.

16. The micro-computer based Real-time Automatic Custody Transfer Measurement System configured on a LACT or ACT unit of claim 15, further configured to log and communicate sensor data to the cloud based interface and data storage system.

17. The micro-computer based Real-time Automatic Custody Transfer Measurement System configured on a LACT or ACT unit of claim 11, further configured to log and store sensor data during communications outages, flagging that data as not yet sent, and configured to communicate the flagged sensor data to the cloud based interface and data storage system at a later time when communications have been restored.

18. The micro-computer based Real-time Automatic Custody Transfer Measurement System configured on a LACT or ACT unit of claim 11, wherein the input/output channels connect to an injection pump controller.

19. The micro-computer based Real-time Automatic Custody Transfer Measurement System configured on a LACT or ACT unit of claim 18, wherein the injection pump controller provides data to the LACT or ACT unit micro-computer system over the input/output channels that comprises at least: injection time data, injection amount data, identity data regarding chemical injections, injection pressure data, and injection flow rate data.

20. The micro-computer based Real-time Automatic Custody Transfer Measurement System configured on a LACT or ACT unit of claim 18, wherein the software program stored on the nonvolatile memory further enables the micro-processor to communicate with the cloud based interface and data storage system to store the data values received from the injection pump controller connected on the input/output channels; and the remote user cloud interface system is further configured to connect to the cloud based interface and data storage system such that the graphical display system configured to display real-time information received from the cloud based interface and data storage system can also display the data values received from the injection pump controller.
